(19) United States
(12) Patent Application Publication
(10) Pub. No.: US 2007/0289763 A1
(43) Pub. Date: Dec. 20, 2007

(54) HAND POWER TOOL

(76) Inventors: Juergen Wiker, Hangzhou/Bing Jiang District (CN); Joachim Schadow, Dettenhausen (DE); Joerg Maute, Sindelfingen (DE)

Correspondence Address: STRIKER, STRIKER & STENBY, 103 EAST NECK ROAD, HUNTINGTON, NY, 11743, US

(21) Appl. No.: 11/744,494

(22) Filed: May 4, 2007

(30) Foreign Application Priority Data
Jun. 16, 2006 (DE) 10 2006 027 784.8

(51) Int. Cl. B25D 16/00

(52) U.S. Cl. 173/162.2

(57) ABSTRACT

In a hand power tool, including a first housing part and a second housing part as well as a damping element between the first housing part and the second housing part, the damping element is connectable to the first housing part and the second housing part, wherein the first housing part and the second housing part are spaced apart from one another longitudinally of the hand power tool.

### CROSS-REFERENCE TO A RELATED APPLICATION

The invention described and claimed hereinbelow is also described in German Patent Application DE 102006027784.8 filed on Jun. 16, 2006. This German Patent Application, whose subject matter is incorporated here by reference, provides the basis for a claim of priority of invention under 35 U.S.C. 119(a)-(d).

### BACKGROUND OF THE INVENTION

The invention is based on a hand power tool.

In work with electrical tools, such as right-angle sanders, drills, and drill hammers, more or less severe vibration occurs, engendered among other factors by the imbalance of the masses, rotating at high speed, of the motor, gear, tool inserts, and so forth, and by the machining of workpieces. The vibration is transmitted to the user of the electrical tool via the handle and causes fatigue in the user's hand. Working for relatively long periods with severely vibrating electrical tools can even impair health.

In German Patent Disclosure DE 195 25 251 A, a vibrating tool is described, with a vibration insulation for insulating the handle from vibration generated by the vibrating tool. The tool housing is provided with a protrusion on its back end. By engagement of a stop on the handle with a flange on the protrusion, the handle is connected to the housing in force-locking fashion, specifically with an interstice between them. A rubber ring is located in the interstice between the handle and the housing. A radially inward-opened groove is provided in the rubber ring, so that the ring is easily deformed when the handle and the housing are displaced relative to one another.

From International Patent Disclosure WO 02/38341 A, a hand power tool is also known in which, on the end remote from the tool mount, a taper that forms a carrier element is integrally molded onto the housing part. The shell housing of the handle fits over the carrier element of the housing part. The housing part and the shell housing are decoupled via a vibration damping unit in the form of an annular gas cushion. The gas cushion is supported in the shell housing radially inward in an annular groove extending over the entire circumference of the carrier element and radially outward in a corresponding second annular groove in the shell housing. The shell housing is secured to the carrier element via a noncontacting form-locking connection.

### SUMMARY OF THE INVENTION

Accordingly, it is an object of the present invention to provide a hand power tool, which is a further improvement of the existing hand power tools.

The hand power tool of the invention, includes a first housing part and a second housing part as well as a damping element between the first housing part and the second housing part, the damping element being connectable to the first housing part and the second housing part, and the first housing part and the second housing part are spaced apart from one another longitudinally of the hand power tool.

Accordingly, there is an interstice between the two housing parts that is filled with the damping element. The connection of the two housing parts to one another is effected solely via the damping element, so that between the two housing parts, there is no direct, rigid connection. Vibration can therefore not be transmitted, or can be transmitted only in damped fashion, from one housing part to the other.

The hand power tool of the invention advantageously has a structurally simple damping element. Furthermore, since no form lock is provided between the two housing parts, no special shaping that would make a form lock possible between the two housing parts is needed in the peripheral regions of the two housing parts, where they are connectable to one another via the damping element. Because of the structurally simple damping element and the simple shaping of the housing parts, the hand power tool overall is simple to produce. Despite the simple construction of the hand power tool of the invention, however, effective vibration damping is achieved. The improved damping properties enhance the user-friendliness of the hand power tool.

In particular, the first housing part and the second housing part are a motor housing and a handle. In some hand power tools, such as right-angle sanders, the housing is constructed of at least two housing parts, which are located in line with one another in the longitudinal axis of the hand power tool and joined together: a rear housing part or motor housing, for instance of plastic, and a front housing part or gearbox, for instance of metal. The motor housing receives an electric motor, among other elements, which via the gear accommodated in the gearbox drives a driven spindle as well as a sanding wheel connected to the driven spindle in a manner fixed against relative rotation. There is a handle at the rear of the rear housing part, that is, the motor housing. The terms “front” and “rear” refer to the working direction of the hand power tool.

The first and second housing parts may each be in one piece, for instance in the form of a cup, so that the components can be introduced into the housing part from the open side. The two housing parts may, however, also be in multiple parts, for instance in two parts, for instance being constructed of two half shells that are joined to one another in the longitudinal axis of the hand power tool and connected to one another. A combination is also possible, for instance in such a way that the first housing part, such as a motor housing, is constructed in two parts of two half shells, and the second housing part, such as a handle, is constructed in one piece from a cup-shaped housing.

The first and second housing parts are preferably of plastic; either the same or different plastics may be used for the two housing parts.

The damping properties of the damping element may be varied by means of material, shape, thickness, and other parameters of the damping element.

The damping element is preferably of an elastic material. Possible examples of elastic materials are elastomers or foams, for instance. The damping element may in particular be of a thermoplastic elastomer.

The damping element is annular or nearly annular, depending on the cross-sectional shape of the two housing parts in their connection region, or rectangular or shaped in other ways. The damping element may be embodied in profiled form, particularly by having a radially outward-oriented bead in the interstice between the two housing parts. The damping element may also be profiled in some other way, to enhance the vibration damping. For instance, the damping element may be provided with circumferentially extending channels, or may have a creased structure.

In a further embodiment, the damping element may also be a spring element, such as a helical spring, spiral spring, leaf spring, or cup spring, for instance of metal of plastic, or a damping cushion filled with a fluid, that is, a gas such as air, or a liquid, such as water, oil, or gel, or it may comprise a net, woven fabric, mesh, knitted fabric, or the like, of metal, plastic or natural material, or a combination of these materials.

The damping element may be connected to the first and second housing parts in various ways. The connection may be done by form locking, for instance by pegs on the damping element that form an undercut with the housing parts. The connection may also be in force-locking fashion, for instance by means of screws or rivets, or by material locking, such as adhesive bonding or welding. A combination of one or more of these types of connection is also possible.

In a simple embodiment, the damping element is connectable to the first and second housing parts by injection molding. A damping element of a thermoplastic elastomer can be integrally molded directly from inside onto the two housing parts in a two-component injection molding process. In that case, the two housing parts are shaped from a thermoplastic in a first cavity of an injection molding tool, for instance. After the two housing parts have been moved into a second cavity of the same injection molding tool (or alternatively a cavity of a second injection molding tool), the damping element comprising a thermoplastic elastomer is integrally formed onto the housing parts.

Alternatively, the damping element may be produced in a separate process and then integrally formed onto the housing parts by injection molding. This is done by placing the separately produced damping element into the cavity of an injection molding tool and sheathing it in the molding of the housing parts in such a way that the damping element is solidly connected to the two housing parts. A prefabricated damping element comprising an elastic material can also be integrally formed in this way onto the housing parts by injection molding. In connecting the damping element by injection molding, a form lock can additionally be attained, for instance by providing that the housing parts have beads, ribs, or other kinds of indentation or protrusions that form an undercut, for instance, with the damping element.

The damping element may be attached to the two housing parts from outside. Preferably, however it is attached from the inside. It can furthermore be attached both from the inside and from the outside. The damping element, for instance of elastic material, can be attached on the outside and inside, overlapping with the housing parts, for instance being integrally molded or glued on.

In one embodiment, at least one retaining element is provided in the first housing part and/or the second housing part, and the damping element can be connected to it. Preferably, at least one retaining element is provided in each of the two housing parts. The retaining elements serve the purpose of securely fastening the damping element to the housing parts. The retaining element may be of metal or plastic, for instance, and a plurality of retaining elements may also be of different materials. One retaining element is connected to each of the housing parts. This can be done in various ways, for instance in form-locking fashion or by means of screws, rivets, clips, adhesive bonding, welding, hot stamping, or other methods.

The damping element in turn is connectable to the retaining element, likewise in various ways. Preferably, the damping element is connected to the retaining element in such a way that the retaining elements are embedded in the damping element. This can be done comparatively simply, for instance by injection molding. The retaining elements are placed in the cavity of the injection molding tool and sheathed by the thermoplastic elastomer in the course of the molding of the damping element.

The hand power tool of the invention is for instance a handheld power right-angle sander.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of one embodiment of a hand power tool of the invention with a damping element;

FIG. 2 shows a detail of a view from inside in the housing of the hand power tool of FIG. 1; and

FIG. 3 is a schematic illustration of one embodiment of a damping element with retaining elements.

### DESCRIPTION OF THE PREFERRED EMBODIMENTS

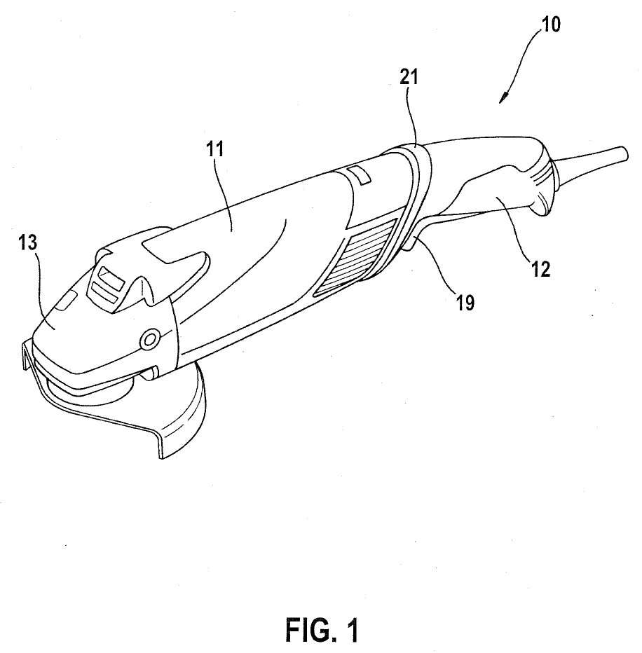

In FIG. 1, one embodiment of a hand power tool of the invention, a power right-angle sander 10, is shown. In the embodiment shown, the power right-angle sander 10 includes three housing parts: a first housing part 11, for receiving an electric motor (not shown), among other things; a second housing part 12, which is embodied as a handle 15; and a third housing part 13, for receiving a gear (not shown), among other things.

A drive shaft that can be driven by an electric motor is coupled to a driven shaft (not shown) via a gear, comprising a driving gear wheel and a driven gear wheel. A sanding wheel (not shown) is located on the driven shaft in a manner fixed against relative rotation. The electric motor is switched on and off by the user via an ON/OFF switch 19.

In the embodiment of FIG. 1, the first housing part 11 and the housing part 12 are of plastic, while the third housing part 13, which is the gearbox, is of metal.

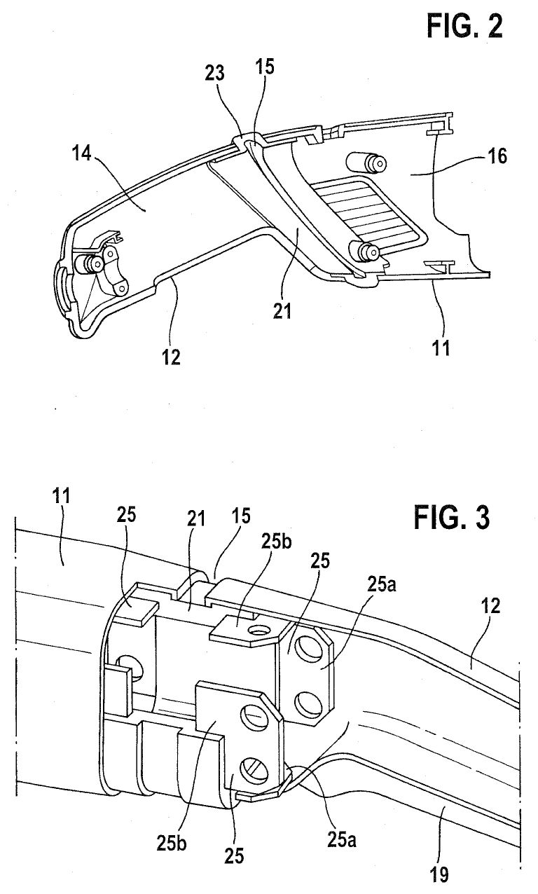

The right-angle power sander 10, in the region between the first housing part 11 or motor housing and the second housing part 12 or handle, has a damping element 21 for vibrationally decoupled or vibration-damped connection of the two housing parts 11, 12. As can be seen in FIG. 1 and especially in the sectional view of FIG. 2, the first housing part 11 and the second housing part 12 are spaced apart from one another longitudinally of the right-angle power sander 10, so that an interstice 15 is formed. The interstice 15 is provided in the form of a gap between the first housing part 11 and the second housing part 12. The damping element 21 fills the interstice 15, and the connection of the two housing parts 11, 12 to one another is effected solely via the damping element 21, so that there is no direct, rigid connection between the two housing parts 11, 12.

The damping element 21 is of an elastic material, in particular a thermoplastic elastomer. It is connected to the first and second housing parts 11, 12 by injection molding; the damping element 21 is integrally molded from inside onto the inner walls 14, 16 of the two housing parts 11, 12. Alternatively, the damping element may also be integrally molded to the housing parts in overlapping fashion (not shown) from outside or from both outside and inside.

The damping element 21 is embodied as nearly annular, so that it extends all the way around in the interstice 15 between the two housing parts 11, 12. In the interstice 15, it has a radially outward-oriented bead 23. As can be seen in FIG. 2, to improve the damping properties, the bead is embodied as essentially U-shaped.

In another embodiment, a damping element 21 of an elastic material is also provided in the interstice 15 between the first housing part 11 and the second housing part 12. For securely fastening the damping element 21 to the housing parts 11, 12, retaining elements 25 are built into the housing parts 11, 12. The retaining elements 25 may be of metal or plastic.

The retaining elements 125 are connected on the one hand each to one of the housing parts 11 or 12. On the other, the retaining elements 25 are connected to the damping element 21. The damping element 21 may for instance be molded to sheathe the retaining elements 25, so that the retaining elements 25 are embedded in the damping element 21.

In the embodiment shown in FIG. 3, the retaining elements 25 comprise a first part 25a, which is connected to a housing part, in this case the housing part 12, and an angled second part 25b, which is connected to the damping element 21.

It will be understood that each of the elements described above, or two or more together, may also find a useful application in other types of constructions differing from the type described above.

While the invention has been illustrated and described as embodied in a hand power tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A hand power tool, comprising a first housing part; a second housing part; a damping element located between said first housing part and said second housing part, said damping element being connectable to said first housing part and to said second housing part, said first housing part and said second housing part being spaced apart from one another longitudinally over the hand power tool.

2. A hand power tool as defined in claim 1, wherein said damping element is configured as a damping element composed of a thermoplastic elastomer.

3. A hand power tool as defined in claim 1, wherein said damping element is configured as a profiled damping element.

4. A hand power tool as defined in claim 4, wherein said damping element is provided with a radially-outward bead.

5. A hand power tool as defined in claim 1, wherein said damping element is configured as a damping element which is injection molding-connected to said first housing part and said second housing part.

6. A hand power tool as defined in claim 1; and further comprising at least one retaining element to which said damping element is connected, said retaining element being provided in a housing part selected from the group consisting of said first housing part, said second housing part, and both.

7. A hand power tool as defined in claim 7, wherein said damping element is configured as a damping element which is injection molding connected to said retaining element.

8. A hand power tool as defined in claim 1, wherein said first housing part and said second housing part are configured as a motor housing and a handle.
